(19) United States
(12) Patent Application Publication
(10) Pub. No.: US 2015/0115881 A1
(43) Pub. Date: Apr. 30, 2015

(54) WIRELESS POWER TRANSCEIVER AND PORTABLE TERMINAL HAVING THE SAME

(71) Applicant: SAMSUNG ELECTRO-MECHANICS CO., LTD., Suwon (KR)

(72) Inventors: Yong Woon PARK, Suwon (KR); Kyung Choon PARK, Suwon (KR); Jae Suk SUNG, Suwon (KR)

(73) Assignee: SAMSUNG ELECTRO-MECHANICS CO., LTD., Suwon (KR)

(21) Appl. No.: 14/520,591

(22) Filed: Oct. 22, 2014

(30) Foreign Application Priority Data
Oct. 25, 2013 (KR) 10-2013-0128015
Dec. 30, 2013 (KR) 10-2013-0167892

(51) Int. Cl. H02J 7/02

(52) U.S. Cl. CPC H02J 7/025
USPC 320/108

(57) ABSTRACT

A wireless power transceiver for wirelessly charging a battery of a portable terminal may include a body having a storage space, a power receiving module stored in the body and receiving power wirelessly from an exterior in a preset scheme to charge the battery, and a power transmitting module stored in the body and transmitting power wirelessly from the battery to an exterior in a preset scheme.

### CROSS-REFERENCE TO RELATED APPLICATION

This application claims the benefit of Korean Patent Application Nos. 10-2013-0128015 filed on Oct. 25, 2013 and 10-2013-0167892 filed on Dec. 30, 2013, with the Korean Intellectual Property Office, the disclosures of which are incorporated herein by reference.

### BACKGROUND

The present disclosure relates to a wireless power transceiver which wirelessly supplies power to a battery, and a portable terminal having the same.

As rapid developments in the field of information communications have progressed, a ubiquitous communications environment in which communications are always available, anywhere, and with anyone has been established, and an age in which more information than ever before is exchanged has arrived.

The development of the modern communications environment has progressed from a limited communications environment such as a wired type communications environment to an environment such as a wireless communications environment, without having temporal and spatial limits.

In order to supply energy to various mobile devices, an important consideration is any such ubiquitous communications environment and a wired type charging method is in general use, but demand for technologies and products capable of supplying energy in a wireless manner or in a non-contact manner have increasingly been made since the late 20th century.

Smartphones, tablet PCs, and office automation machines in daily use are installed in designated spaces and use electrical energy which is supplied in the wired manner.

Particularly, in the case of devices having limited mobility and a low need for portability, there may be little inconvenience for users in supplying power in the wired manner, but the development and increasingly widespread use of smartphones and tablet PCs in recent times demonstrate that the wired power supply method has limitations as a power supply source in the case of mobile devices.

For example, interest in battery charging capacity and efficiency has increased among various reactions according to the release of new models of portable devices.

Due to the fact that battery performance may be reduced when using functions such as Internet search, mobile banking, social network services (SNS), and the like in a mobile-based communications environment, battery charge characteristics have grown in importance.

Portable auxiliary battery products have also been released in order to compensate for the above-mentioned problems, but since it is somewhat inconvenient to carry auxiliary batteries and it is necessary to charge such batteries in the wired manner, this may not be a sufficient improvement.

In the case of portable devices, including smartphones, the charging capacity of batteries may not be able to be infinitely increased, due to differing product designs, and the rapid development of battery performance cannot be expected, due to the physical limitations of mobile device battery size.

Thus, in a modern ubiquitous communications environment, it may be difficult to easily charge portable devices anywhere.

In the case in which all of wires used in the above-mentioned wired manner are removed, positions of mobile devices are not determined depending on the lengths of charging cords thereof, and mobile devices are able to be charged with electrical energy to be used while moving freely within a region to which electrical energy is transferred; it may be seen that a revolutionary change will occur in terms of emphasis on the portability of products such as portable devices.

In accordance with the recent development of the mobile devices able to be used together with smartphones, such as wearable devices like smartwatches, wireless computer mice, Bluetooth headsets, and the like, many products have been released. Since these products consume about 10 to 25% of the power consumed by the latest smartphones, demand for simple charging during movement has increased.

The following related art document discloses technical contents of the supply of power to a charger embedded in an electronic device in a non-contact manner through a magnetic induction effect or a magnetic resonance effect, but does not disclose technical contents in which charging or power reception and power transmission are provided by a single device during movement.

### RELATED ART DOCUMENT

Korean Patent Laid-Open Publication No. 2013-0054897

### SUMMARY

Some embodiments in the present disclosure may provide a wireless power transceiver in which power reception and power transmission are provided by a single device, and a portable terminal having the same.

According to some embodiments in the present disclosure, a wireless power transceiver wirelessly charging a battery of a portable terminal may include: a body having a storage space; a power receiving module stored in the body and receiving power wirelessly from an exterior in a preset scheme to charge the battery; and a power transmitting module stored in the body and transmitting power wirelessly from the battery to an exterior in a preset scheme.

The wireless power transceiver may further include a controlling unit controlling operations of the power receiving module and the power transmitting module according to battery power state information.

The controlling unit may select the operation of the power receiving module and the operation of the power transmitting module according to a power level of the battery.

The controlling unit may select charging the battery with power supplied from an exterior in a wired manner or wirelessly transmitting the power charged in the battery in the wired manner to the exterior.

The body may be a case cover opening or closing a storage part in which the battery is stored in the portable terminal.

The case cover may include: a first storage space in which the power receiving module is stored; and a second storage space in which the power transmitting module is stored.

The power receiving module may include a power receiving controlling unit controlling power reception and a power receiving coil receiving power from an exterior, and the power transmitting module may include a power transmitting controlling unit controlling power transmission and a power transmitting coil transmitting power to the exterior according to a control of the power transmitting controlling unit.

The power receiving module may include a power receiving controlling unit controlling power reception, the power transmitting module may include a power transmitting unit controlling power transmission, and the power receiving module and the power transmitting module may wirelessly transmit and receive power by commonly using a single coil.

The power receiving module and the power transmitting module may commonly use a power transmitting and receiving controlling unit controlling transmission and reception of power.

According to some embodiments in the present disclosure, a portable terminal may include: a portable terminal body; a battery stored in a storage part provided in the portable terminal body to provide charged power to the portable terminal body; and a wireless power transceiver having a case cover having a storage space and opening and closing the storage part of the portable terminal body in which the battery is stored; a power receiving module stored in the case cover and receiving power wirelessly from an exterior in a preset scheme to charge the battery; and a power transmitting module stored in the case cover and transmitting power wirelessly from the battery to an exterior in a preset scheme.

The wireless power transceiver may further include a controlling unit controlling operations of the power receiving module and the power transmitting module according to battery power state information.

The controlling unit may select the operation of the power receiving module and the operation of the power transmitting module according to a power level of the battery.

The portable terminal body may detect a power level of the battery to select the operation of the power receiving module and the operation of the power transmitting module.

The portable terminal body may select charging the battery with power supplied from an exterior in a wired manner or wirelessly transmitting the power charged in the battery in the wired manner to the exterior.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1A is a schematic exploded perspective view of a portable terminal having a wireless power transceiver according to an embodiment in the present disclosure;

FIG. 1B is a schematic side perspective view of the portable terminal having the wireless power transceiver according to an embodiment in the present disclosure;

FIGS. 2A through 2C are side perspective views schematically illustrating the wireless power transceiver according to embodiments in the present disclosure;

FIG. 3 is a schematic block diagram of a wireless power transceiver according to an embodiment in the present disclosure; and

FIGS. 4 and 5 are operation flowcharts of a wireless power transceiver according to an embodiment in the present disclosure.

### DETAILED DESCRIPTION

Hereinafter, embodiments in the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

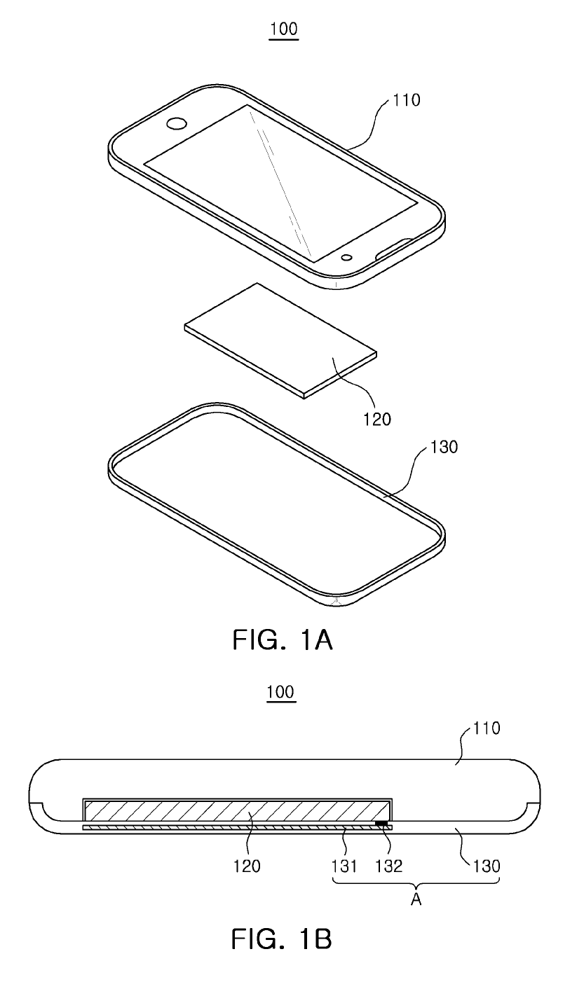

FIG. 1A is a schematic exploded perspective view of a portable terminal having a wireless power transceiver according to an embodiment in the present disclosure and FIG. 1B is a schematic side perspective view of the portable terminal having the wireless power transceiver according to an embodiment in the present disclosure.

Referring to FIGS. 1A and 1B, a portable terminal 100 according to an embodiment in the present disclosure may include a portable terminal body 110, a battery 120, and a case cover 130.

The portable terminal 100 according to an embodiment in the present disclosure may be various types of portable communications device, such as a mobile communications terminal, a smartphone, a personal digital assistant (PDA), and the like, and may be various portable electronic devices such as an MP3 player, a portable multimedia player (PMP), and the like.

The portable terminal body 110 may perform a preset electrical operation and may require driving power to perform the preset electrical operation.

To this end, the portable terminal body 110 may be provided with a storage part and the storage part may store the battery 120.

The battery 120 may be stored in the portable terminal body 110 and provide a charged direct current to the portable terminal body 110 to enable the portable terminal body 110 to perform a set operation.

To this end, the battery 120 may be charged with power, and examples of charging the battery 120 with the power may include a method of inserting a power plug into the portable terminal body 110 to charge the battery in a wired manner and a method of wirelessly supplying power to the battery from the exterior.

A wireless power transceiver A may be adopted to wirelessly charge the battery 120, and a body 130 of the wireless power transceiver A may be coupled to the portable terminal body 110. The body 130 of the wireless power transceiver A may be a case cover 130 opening or closing the storage part in which the battery 120 of the portable terminal body 110 is stored.

The case cover 130 may have the storage part provided therein, the storage part may have a power transmitting or receiving module 131 stored therein, and when the power transmitting or receiving module 131 wirelessly receives power from the exterior, it may charge the battery 120 with power through a terminal 132.

On the other hand, the wireless power transceiver A according to an embodiment in the present disclosure may charge the battery 120 with power in a preset wireless scheme and may also wirelessly transmit the power charged in the battery 120 to the exterior. To this end, the power transmitting or receiving module 131 may receive the power charged in the battery 120 through the terminal 132 and wirelessly transmit the power to the exterior.

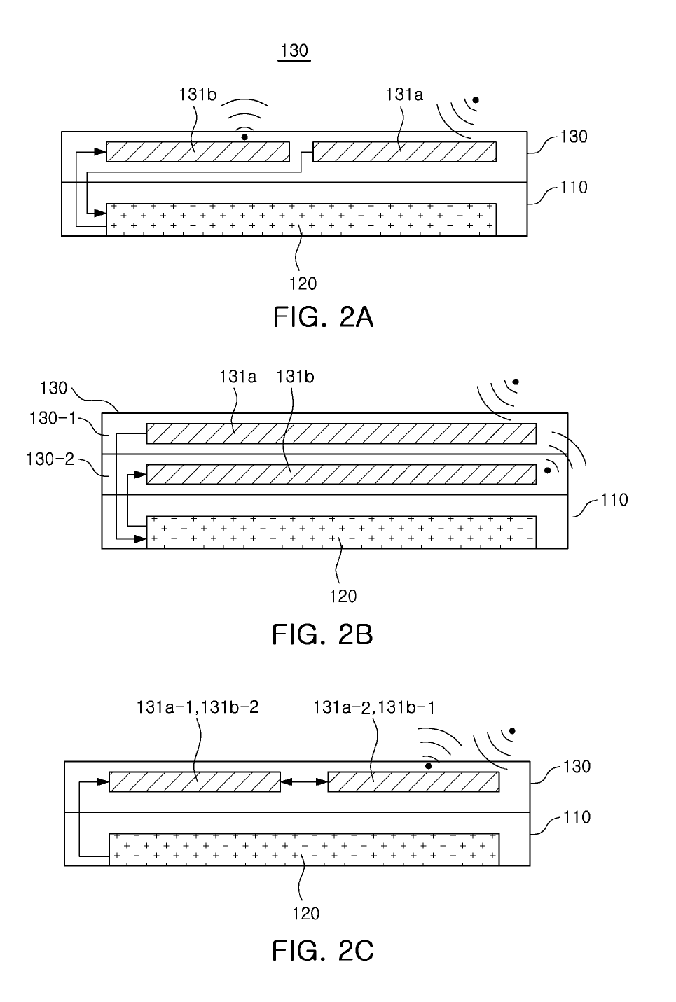

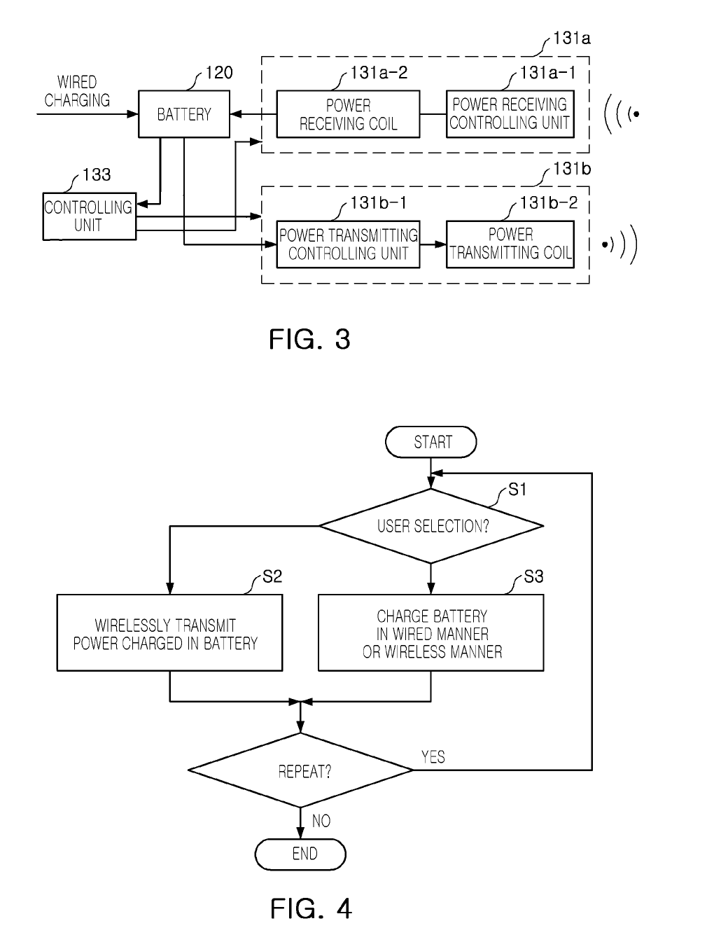

FIGS. 2A through 2C are side perspective views schematically illustrating the wireless power transceiver according to embodiments in the present disclosure and FIG. 3 is a schematic block diagram of the wireless power transceiver according to an embodiment in the present disclosure.

Referring to FIG. 2A, the case cover 130 may have a power transmitting module 131b and a power receiving module 131a stored therein, and the portable terminal body 110 may be provided with a storage part for storing the battery 120.

Although the drawings illustrate a case in which a thickness of the case cover 130 is thicker than that of the portable terminal body 110, this merely illustrates an extreme case in which the thickness of the case cover 130 is thick for convenience of explanation, and the thickness of the case cover 130 comprised in the wireless power transceiver according to an embodiment in the present disclosure may not have a substantial difference from a thickness of a general case cover coupled to a rear surface of the portable terminal body 110 and is not limited to the drawings.

The battery 120 may supply the charged power to the power transmitting module 131b and the battery 120 may also receive the power which is wirelessly received from the power receiving module 131a and may be charged with the power.

The case cover 130 may be provided with at least one storage part for storing the power transmitting module 131b and the power receiving module 131a, and may be provided with a first storage space 130-1 and a second storage space 130-2, as illustrated in FIG. 2B to store the power transmitting module 131b or the power receiving module 131a in the first storage space 130-1 and the second storage space 130-2, respectively.

Meanwhile, referring to FIG. 3, the power receiving module 131a may include a power receiving coil 131a-1 which wirelessly receives power and a power receiving controlling unit 131a-2 which controls the wireless power reception, and the power transmitting module 131b may include a power transmitting controlling unit 131b-1 controlling the wireless power transmission and a power transmitting coil 131b-2 which wirelessly transmits power.

In addition, the wireless power transceiver according to an embodiment in the present disclosure may further include a controlling unit 133, and the controlling unit 133 may control operations of the power receiving module 131a and the power transmitting module 131b depending on battery power state information, and in more detail, may selectively control the operations of the power receiving module 131a and the power transmitting module 131b depending on a power level of the battery.

In addition, the controlling unit 133 may charge the battery with power from an exterior device such as an adaptor in the wired manner and may perform a control so that the power charged in the battery in the wired manner may be wirelessly transmitted to the exterior through the power transmitting module 131b. As illustrated, the power which is received in the wired manner is charged in the battery and may be then wirelessly transmitted, but the present disclosure is not limited thereto. For example, the power which is received in the wired manner may be controlled to be wirelessly transmitted immediately.

As illustrated in FIG. 2C, the power receiving controlling unit 131a-2 and the power transmitting controlling unit 131b-1 may be configured as a single module to be commonly used for controlling power transmission and reception, and the power receiving coil 131a-1 and the power transmitting coil 131b-2 may be configured as a single coil to be commonly used for transmitting and receiving power.

The power receiving controlling unit 131a-2 and the power transmitting controlling unit 131b-1 may perform a control so that the power is wirelessly transmitted or received in a magnetic resonance type or a magnetic induction type.

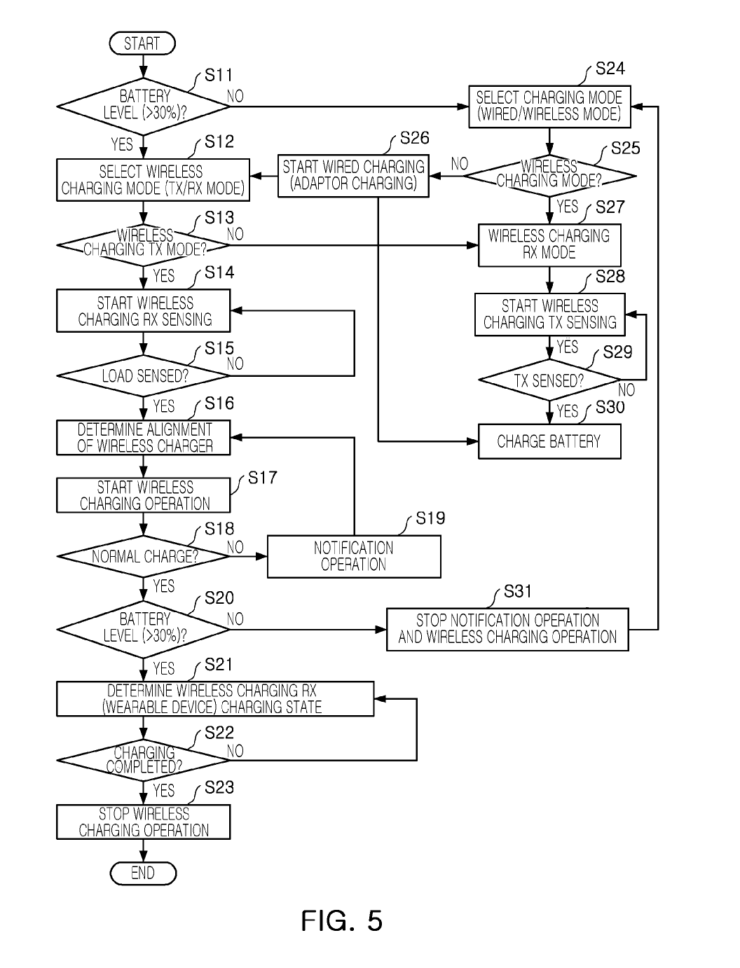

FIGS. 4 and 5 are operation flowcharts of the wireless power transceiver according to an embodiment in the present disclosure.

First, referring to FIG. 4, in a schematic operation flow of the wireless power transceiver according to an embodiment in the present disclosure, depending on a selection of a user (S1), power charged in a battery may be wirelessly transmitted to an exterior (S2) or may charge the battery with power in a wireless manner or a wired manner. The foregoing operations may be controlled by a controlling unit, and may also be controlled by a program of a body of a portable terminal or a controlling circuit with reference to FIG. 5. In this case, the controlling unit may be the program of the portable terminal body or the controlling circuit.

Referring to FIG. 5, the portable terminal having the wireless power transceiver according to an embodiment in the present disclosure may change a wireless charging mode depending on a battery power level.

For example, in the case in which the battery power level of the portable terminal is 30% or less, the battery embedded in the portable terminal may be charged in a wired charging manner or a wireless charging manner.

For example, the portable terminal may select a wired mode to receive power from a power device such as an adaptor or a wireless mode to wirelessly receive power from an exterior wireless power supplying device.

In the case in which the wireless mode is selected, the wireless power transceiver and the portable terminal according to the present disclosure may prepare to wirelessly receive power through the power receiving coil, search whether or not the wireless power transmitting device is present on the periphery to this end, and receive power when the wireless power transmitting device is present to thereby charge the battery of the portable terminal with power.

On the contrary, in the case in which the wired mode is selected, the portable terminal may receive power through a device such as a power transferring cable or a plug, from the power device such as the adaptor to thereby charge the battery of the portable terminal with power, may charge the battery according to a control, and may wirelessly transmit the power charged in the battery in the wired manner to the exterior (S11, S24, S25, S26, S27, S28, S29, S30). As illustrated, the power which is received in the wired manner is charged in the battery and may be then wirelessly transmitted, but the present disclosure is not limited thereto. For example, the power which is received in the wired manner may be controlled to be wirelessly transmitted immediately.

On the other hand, in the case in which the battery power level of the portable terminal is 30% or more, the portable terminal may select the power transmitting mode or the power receiving mode. In case of selecting the power transmitting mode, the power transmitting module may sense a charging target device capable of wirelessly receiving the power to thereby start a wireless charging operation.

In this case, the power transmitting module may determine an alignment of the charging target devices according to the wireless charging scheme and may then start the wireless charging operation.

Next, in the case in which the battery power level of the portable terminal is 30% or less during the wireless charging, the portable terminal may ask a user whether or not the wireless charging should be stopped.

The forgoing charging target device may be a wearable device such as a smartwatch or a portable terminal having a wireless charging function.

In addition, in the case in which charging is not normally performed, the alignment of the charging target devices may be re-determined by a notification operation, and in the case in which the battery power level of the portable terminal again rises to 30% or more after the normal charging starts, the power may be continuously supplied to the charging target device in a wireless manner, and further, when the charging is completed, the wireless charging operation may be stopped. In addition, in the case in which the battery power level of the portable terminal is 30% or less, the wireless charging operation may be stopped after the notification operation (S12, S13, S14, S15, S16, S17, S18, S19, S20, S21, S22, S23, S31).

As set forth above, according to embodiments in the present disclosure, since the power reception and the power transmission are provided by a single device, the wireless transceiver and the portable terminal having the same may be configured to be slim, and since the power reception and the power transmission are provided by a single device, the wireless charging during the movement or the wireless charging function may be provided to various devices such as the wearable device, and the wireless charging function may be provided to various devices such as the wearable devices even during the wired charging of the portable terminal.

While embodiments have been shown and described above, it will be apparent to those skilled in the art that modifications and variations could be made without departing from the scope of the present invention as defined by the appended claims.

What is claimed is:

1. A wireless power transceiver for wirelessly charging a battery of a portable terminal, the wireless power transceiver comprising:
a body having a storage space;
a power receiving module stored in the body and receiving power wirelessly from an exterior to charge the battery; and
a power transmitting module stored in the body and transmitting power wirelessly from the battery to an exterior.

2. The wireless power transceiver of claim 1, further comprising a controlling unit controlling operations of the power receiving module and the power transmitting module according to battery power state information.

3. The wireless power transceiver of claim 2, wherein the controlling unit selects the operation of the power receiving module and the operation of the power transmitting module according to a power level of the battery.

4. The wireless power transceiver of claim 2, wherein the controlling unit selects charging the battery with power supplied from an exterior in a wired manner or wirelessly transmitting the power charged in the battery in the wired manner to the exterior.

5. The wireless power transceiver of claim 1, wherein the body is a case cover opening or closing a storage part in which the battery is stored in the portable terminal.

6. The wireless power transceiver of claim 5, wherein the case cover includes:
a first storage space in which the power receiving module is stored; and
a second storage space in which the power transmitting module is stored.

7. The wireless power transceiver of claim 1, wherein the power receiving module includes a power receiving controlling unit controlling power reception, and a power receiving coil receiving power from an exterior, and
the power transmitting module includes a power transmitting controlling unit controlling power transmission and a power transmitting coil transmitting power to the exterior according to a control of the power transmitting controlling unit.

8. The wireless power transceiver of claim 1, wherein the power receiving module includes a power receiving controlling unit controlling power reception,
the power transmitting module includes a power transmitting unit controlling power transmission, and
the power receiving module and the power transmitting module wirelessly transmit and receive power by commonly using a single coil.

9. The wireless power transceiver of claim 1, wherein the power receiving module and the power transmitting module commonly use a power transmitting and receiving controlling unit controlling transmission and reception of power.

10. A portable terminal comprising:
a portable terminal body;
a battery stored in a storage part provided in the portable terminal body to provide charged power to the portable terminal body; and
a wireless power transceiver having a case cover having a storage space and opening and closing the storage part of the portable terminal body in which the battery is stored; a power receiving module stored in the case cover and receiving power wirelessly from an exterior to charge the battery; and a power transmitting module stored in the case cover and transmitting power wirelessly from the battery to an exterior.

11. The portable terminal of claim 10, wherein the wireless power transceiver further comprises a controlling unit controlling operations of the power receiving module and the power transmitting module according to battery power state information.

12. The portable terminal of claim 11, wherein the controlling unit selects the operation of the power receiving module and the operation of the power transmitting module according to a power level of the battery.

13. The portable terminal of claim 12, wherein the portable terminal body detects the power level of the battery to select the operation of the power receiving module and the operation of the power transmitting module.

14. The portable terminal of claim 10, wherein the portable terminal body selects charging the battery with power supplied from an exterior in a wired manner or wirelessly transmitting the power charged in the battery in the wired manner to the exterior.

15. The portable terminal of claim 10, wherein the case cover includes:
a first storage space in which the power receiving module is stored; and
a second storage space in which the power transmitting module is stored.

16. The portable terminal of claim 10, wherein the power receiving module includes a power receiving controlling unit controlling power reception, and a power receiving coil receiving power from an exterior, and
the power transmitting module includes a power transmitting controlling unit controlling power transmission and a power transmitting coil transmitting power to the exterior according to a control of the power transmitting controlling unit.

17. The portable terminal of claim 10, wherein the power receiving module includes a power receiving controlling unit controlling power reception,
the power transmitting module includes a power transmitting controlling unit controlling power transmission, and
the power receiving module and the power transmitting module wirelessly transmit and receive power by commonly using a single coil.

18. The portable terminal of claim 10, wherein the power receiving module and the power transmitting module commonly use a power transmitting and receiving controlling unit controlling transmission and reception of power.
